(19) United States
(12) Patent Application Publication
(10) Pub. No.: US 2013/0299353 A1
(43) Pub. Date: Nov. 14, 2013

(54) METHOD OF FORMING INTERFERENCE FILM ON SURFACE OF ALUMINUM ALLOY SUBSTRATE

(71) Applicants: SHAO-KANG HU, TAINAN CITY (TW); FENG-JU LAI, TAIPEI CITY (TW); HWAI-SHAN CHEN, TAICHUNG CITY (TW)

(72) Inventors: SHAO-KANG HU, TAINAN CITY (TW); FENG-JU LAI, TAIPEI CITY (TW); HWAI-SHAN CHEN, TAICHUNG CITY (TW)

(73) Assignee: CATCHER TECHNOLOGY CO., LTD., TAINAN CITY (TW)

(21) Appl. No.: 13/470,300

(22) Filed: May 12, 2012

(51) Int. Cl. B32B 15/04; C25D 5/48; C25D 5/44

(52) U.S. Cl. 205/50; 205/203

(57) ABSTRACT

A method of forming an interference film on an aluminum alloy substrate includes the following steps: providing an aluminum alloy substrate; cleaning the aluminum alloy substrate through a pre-treatment process; performing an anodic treatment on the aluminum alloy substrate for a predetermined amount of time till an oxidized film having a plurality of cellular tubes is formed on the surface thereof; expanding the holes of the oxidized membrane of the aluminum alloy substrate with an acidic solution to enlarge the diameter of the cellular tubes; enlarging the bottom of the cellular tubes to form a deposition area through an electrical enlarging process; depositing a metal material on the deposition area of the cellular tubes to form an interference structure; sealing the cellular tubes with a sealing agent; and removing dirt. Furthermore, an interference film structure is formed on the aluminum alloy substrate using the aforementioned method.

### BACKGROUND OF THE INSTANT DISCLOSURE

1. Field of the Instant Disclosure

The instant disclosure relates to a method of forming an interference film on a surface of an aluminum alloy substrate and a structure having the same; in particular, to a method of forming an interference film on a surface of an aluminum alloy substrate by means of electrolysis through an anodic treatment and a structure having the same.

2. Description of Related Art

The coloration of a metallic housing has already been widely researched and applied. Generally, the anodic treatment is often utilized in such field. However, the forming of only one color on the metallic housing through the anodic treatment can barely satisfy the aesthetic demands of the consumers.

In addition, existing electrolysis coloration on the aluminum substrate uses alternation of currents, includes adding nickel salt directly into the solution for electroplating to produce color. However, the formed oxide film of the colored aluminum substrate from the anodic treatment is mono-colored. Whereas an interference film is able to show various colorations when observing from different angles.

Thus, in order to meet the consumer demands, the goal of applying light interference to the aluminum alloy substrate for producing different colors when observing from different angles and a mass production method are eagerly searched by industrial manufacturers.

### SUMMARY OF THE INSTANT DISCLOSURE

The object of the instant disclosure is to provide a method of forming an interference film on a surface of an aluminum alloy substrate and a structure having the same. In particular, light interference will occur on the surface of the aluminum alloy, and thereby, different colors will appear from the surface when observing from different angles.

In order to achieve the aforementioned objects, according to an embodiment of the instant disclosure, a method of forming an interference film on a surface of an aluminum alloy is provided, which includes the following steps: providing an aluminum alloy substrate; cleaning the surface of the aluminum alloy substrate through a pre-treatment process; anodizing the aluminum alloy substrate for a predetermined amount of time until an oxidized film having a plurality of cellular tubes is formed on the surface thereof; expanding the holes of the oxidized membrane of the aluminum alloy substrate with an acidic solution to enlarge the diameter of the cellular tubes; enlarging the bottom portions of the cellular tubes to form a deposition area through an electrical enlarging process; depositing a particular metal on the deposition area of the cellular tubes to form an interference structure; sealing the cellular tubes with a sealing agent; and removing dirt.

In order to achieve the aforementioned objects, according to an embodiment of the instant disclosure, an interference film structure is provided on an oxidized membrane of an aluminum alloy substrate. The oxidized membrane includes a plurality of cellular tubes, and the interference film structure includes a plurality of deposition areas formed on the bottom of the cellular tubes. The diameter of the deposition areas is greater than that of the cellular tubes. A plurality of reflective portions is formed by metallic ions and partially arranged inside the deposition area. A sealing layer is covered on the oxidized membrane.

Based on the above, the instant disclosure has the following advantages: light interference will occur on the surface of the aluminum alloy for different color to appear when observing from different angles, and thereby, enhancing the aluminum alloy aesthetically.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a flow chart of a method of forming an interference film on a surface of an aluminum alloy according to the instant disclosure;

FIG. 2 shows an enlarged cross-sectional view of an oxidized membrane of a aluminum alloy substrate formed after an anodic treatment according to the instant disclosure;

FIG. 3 shows an enlarged cross-sectional view of the aluminum alloy substrate after a hole expansion process according to the instant disclosure;

FIG. 4 shows an enlarged cross-sectional view of the aluminum alloy substrate after an electrical enlarging process according to the instant disclosure;

FIG. 5 shows an enlarged cross-sectional view of the bottom of the cellular tubes after the deposition of a metal material according to the instant disclosure;

FIG. 6 shows a schematic view of light interference and the interference film structure of the aluminum alloy surface according to the instant disclosure.

### DETAILED DESCRIPTION OF THE PREFERRED EMBODIMENTS

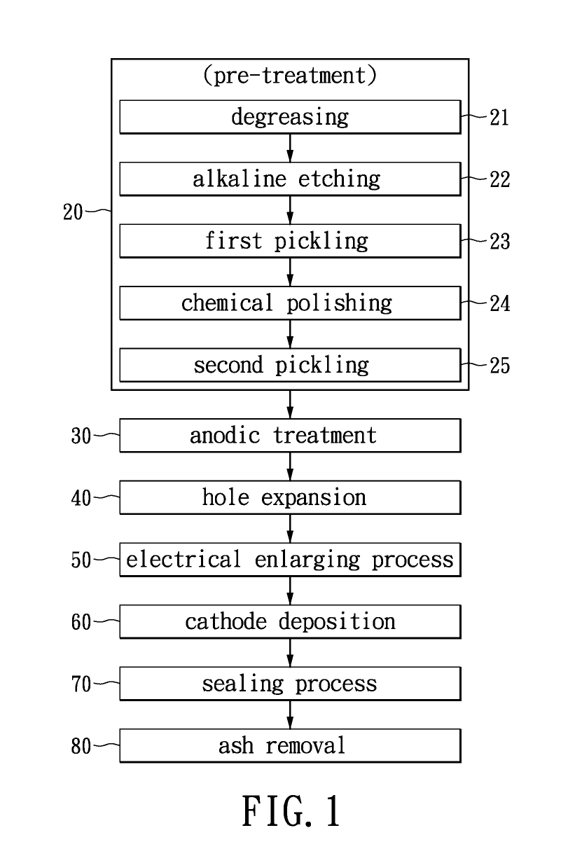

Please refer to FIG. 1, which shows a flow chart of a method of forming an interference film on a surface of an aluminum alloy according to the instant disclosure. The method includes the following steps, which will be explained in greater details hereinafter.

Firstly, an aluminum alloy substrate is provided, where the substrate can be a housing or a body of any device, such as the housing of an electronic product, the body of a bicycle, or a small ornamental metallic work piece, etc.

Next, for step S20, cleaning the surface of the aluminum alloy substrate through a pre-treatment process. This process includes at least five sub-procedures.

Next, for step S30, an anodic treatment is performed on the aluminum alloy substrate for a predetermined amount of time until an oxidized film having a plurality of cellular tubes is formed on the surface thereof. This process is referred herein as “the anodic treatment”.

Next, for step 40, the holes of the oxidized membrane of the aluminum alloy substrate are expanded with an acidic solution to enlarge the diameter of the cellular tubes. This step is referred herein as “the hole expansion” and electricity is not conducted in this process.

Next, for step 50, the bottom portions of the cellular tubes are expanded to form a deposition area through an electrical enlarging process. This process is referred herein as “the electrical enlargement”.

Next, for step 60, a particular material is deposited on the deposition area of the cellular tubes to form an interference structure. This process is referred herein as “the cathode deposition”.

Then, for step 70, the cellular tubes are sealed with a sealing agent. This process is referred herein as the “sealing process”. Lastly, for step 80, debris are removed from the substrate.

For the aforementioned step 20, the pre-treatment step includes sub-procedures such as degreasing (step 21), alkaline etching (step 22), first pickling (step 23), chemical polishing (step 24), and second pickling (step 25). The number of times in performing these sub-procedures depends on the quality requirement of the aluminum alloy substrate. Furthermore, at least one water-rinsing process is included after each sub-procedure, and the number of times of the water-rinsing process can range from one to five. Preferably, two water-rinsing processes are employed for the removal of the chemical agents and other impurities from the previous sub-procedure. For the parameter range of each sub-procedure, please refer to the following table for more details.

TABLE 1
Parameters of each sub-procedure in
the pre-treatment process (step 20)

| | | Parameter range | |
|---|---|---|---|
| Step | Sub-procedure | Parameter 1 | Parameter 2 |
| Pre- | Degreasing | Degreasing agent: 1-50% | Temperature: |
| treatment | | | 10-90° C. |
| | Water-rinsing | Temperature: 5-95° C. | 1-5 times |
| | Alkaline etching | Alkali: 50-500 g/L | Temperature: |
| | | | 10-90° C. |
| | Water-rinsing | Temperature: 5-95° C. | 1-5 times |
| | Chemical polishing | Acid: 1-85% | Temperature: |
| | | | 10-90° C. |
| | Water-rinsing | Temperature: 5-95° C. | 1-5 times |
| | Pickling | Acid: 50-500 ml/L | Temperature: |
| | | | 10-90° C. |
| | Water-rinsing | Temperature: 5-95° C. | 1-5 times |

Practically, the aforementioned sub-procedures can be adjusted according to the condition of the aluminum alloy and the applied situation. For the instant disclosure, a housing of the electronic device is employed for illustrative purpose. Furthermore, after different examinations and evaluations performed by the inventor, some preferred parameters for the sub-procedures of the pre-treatment step are provided in the following table.

TABLE 1A
Preferred parameters of the sub-procedures.

Parameter range

| Sub-procedure | Parameter 1 | Parameter 2 |
|---|---|---|
| Degreasing | Degreasing agent: 3-5% | Temperature: |
| | | 50° C. |
| Water-rinsing | Temperature: about 25° C. | 2 times |
| Alkaline etching | NaOH: 220 g/L | Temperature: |
| | | about 25° C. |
| Water-rinsing | Temperature: about 25° C. | 2 times |
| Chemical polishing | Phosphoric Acid | Temperature: |
| | | 90-93° C. |
| Water-rinsing | Temperature: about 25° C. | 2 times |
| Pickling | Nitric Acid: 5 ml/L | Temperature: |
| | | about 25° C. |
| Water-rinsing | Temperature: about 25° C. | 2 times |

After cleaning the aluminum alloy substrate, the condition of the substrate will be ready for the next step, which is the anodic treatment. For the anodic treatment, the aluminum alloy substrate is dipped into an electrolytic bath and is connected to an anode, while a cathode is connected to a carbon or lead plate before a current and a voltage is applied. Because aluminum and aluminum alloy oxidizes easily, the anodic treatment is utilized to control the formation of the oxidized layer through the electrochemical method. Hence, excessive oxidation of the aluminum material can be prevented while the mechanical property of the metal surface can be enhanced. Since the chemical reactions that occur during anodization are already well-known, no further elaborations shall be provided herein

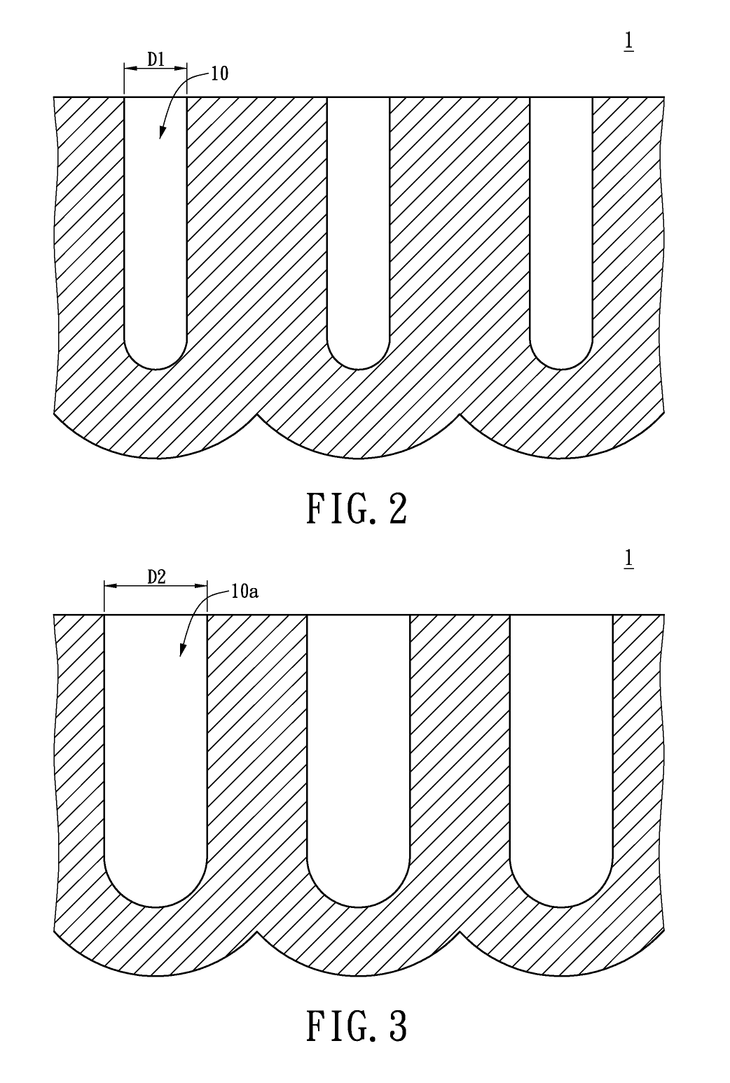

Please refer to FIG. 2, which shows an enlarged cross-sectional view of an oxidized membrane of the aluminum alloy substrate after the anodic treatment according to the instant disclosure. The surface of the aluminum alloy substrate 1 has an oxidized membrane having a plurality of cellular tubes 10 formed thereon after the anodic treatment. An diameter D1 of each cellular tubes 10 is approximately 17 nm on average. The dimension provided, however, is only for reference, as the actual diameter can vary according to different parameters. The parameter range of the anodic treatment of the instant disclosure is shown in Table 2 below.

TABLE 2
Parameter range of the anodic treatment (step 30)

| | Parameter range | |
|---|---|---|
| Step | Parameter 1 | Parameter 2 |
| Anodic treatment | Phosphoric acid and/or | Temperature: 5-50° C.; |
| | oxalic acid or phosphoric | Current density: |
| | acid and/or boric acid | 0.2-3.0 A/dm² |
| | and/or tartaric acid 1-95% | Time: 10-60 minutes |
| Water-rinsing | Temperature: 5-95° C. | 1-5 times |

Some preferred parameter after further testing include dipping the substrate into a sulfuric acid solution having a concentration of 20-25% by weight, where the temperature ranges from 15° C.-25° C., the current density is 0.6 A/dm², and the time spent is at least 30 minutes. Preferably, the water-rinsing process is conducted under a temperature of 25° C. for two times.

The step of hole expansion is performed after the anodic treatment, for the purpose is to enlarge the diameter of the cellular tubes 10 and to regulate the shape thereof for the latter deposition step to proceed more easily. The parameter range of the hole expansion step is shown in Table 3 below.

TABLE 3
Parameter range of the hole expansion (step 40)

| | Parameter range | |
|---|---|---|
| Step | Parameter 1 | Parameter 2 |
| Hole expansion | Phosphoric acid and/or | Temperature: 5-95° C.; |
| | oxalic acid or phosphoric | Time: 1-30 minutes |
| | acid and/or boric acid | |
| | and/or tartaric acid 1-95% | |
| Water-rinsing | Temperature: 5-95° C. | 1-5 times |

Some preferred parameters for the hole expansion step after further testing include dipping the substrate into a phosphoric acid solution having a concentration of 85% by weight, where the temperature ranges from 20° C.-25° C., and the time spent is 7 minutes. Preferably, the water-rinsing process is conducted under a temperature of 25° C. for two times. An enlarged cross-sectional view of the aluminum alloy substrate after the step of hole expansion is shown in FIG. 3. A diameter D2 of each cellular tube 10a is approximately 28 nm on average. The dimension provided, however, is only for reference, as the actual diameter can varies according to different parameters.

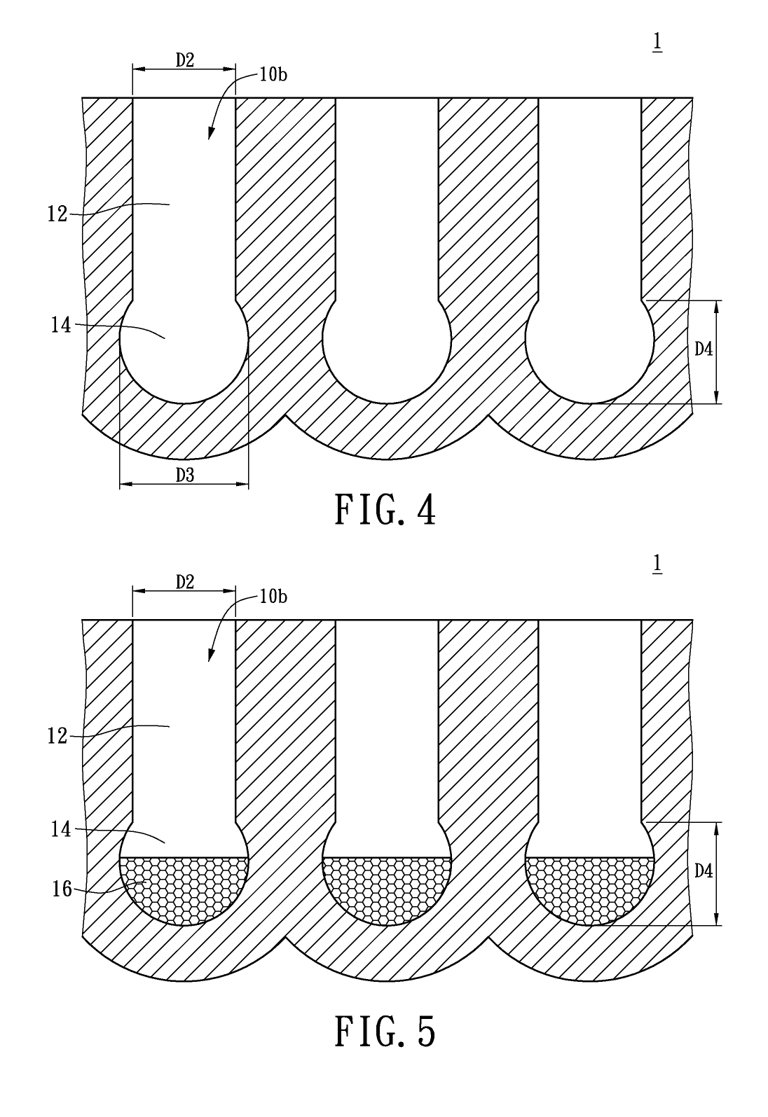

The electrical enlarging process of step 50 is performed after the hole expansion of step 40. For the electrical enlarging process, the aluminum alloy is connected to the anode, while the carbon plate or lead plate is connected to the cathode. The power source can be selected from the group of direct current, alternating current, or pulse power source. With reference to FIG. 4, the object of the electrical enlarging process is to further enlarge the bottom of the cellular tubes 10b by means of electrolysis to form a deposition area 14 respectively therein. The shape of the deposition area 14 shown in the figure is only for illustrative purpose, where the main purpose of the electrical enlarging step is to allow the bottom portion of the cellular tubes 10b to expand slightly sideways or in a downward direction. The parameter range of the electrical enlarging step is shown in Table 4 below.

TABLE 4
Parameter range of the electrical enlarging process (step 50)

| | Parameter range | |
|---|---|---|
| Step | Parameter 1 | Parameter 2 |
| Electrical | Phosphoric acid and/or | Temperature: 5-95° C.; |
| enlarging process | oxalic acid or phosphoric | Direct current: 1-70 V |
| | acid and/or boric acid | Alternating current: |
| | and/or tartaric acid 1-95% | 1-70 V/10 HZ-90 HZ |
| | | Pulse power source: |
| | | 1-70 V/1-254 ms |
| | | Time: 1-40 minutes |
| Water-rinsing | Temperature: 5-95° C. | 1-5 times |

Some preferred parameters for the electrical enlarging process of step 50 include dipping the substrate in a phosphoric acid solution having a concentration of 150 g/L, where the temperature ranges from 20° C.-25° C., and a 10 volt direct current is conducted for 5 minutes. Preferably, the water-rinsing process is conducted under a temperature of 25° C. for two times. As shown in FIG. 4, a width D3 of the deposition area 14 is greater than that of the upper portion of the cellular tubes 12. Namely, the width D3 of the cellular tube is approximately 35 nm, and a height D4 is approximately 0.5-1 nm. For illustrative purpose, the height of the deposition area 14 in the figure is exaggerated for easier understanding.

The cathode deposition of step 60 is performed after the electrical enlarging process of step 50. Generally, the aluminum alloy substrate is connected to the cathode, while the anode is connected to the carbon plate or lead plate. The solution includes acidic fluid and metal salts. The power source can be direct current, alternating current, or pulse power source. The purpose is to deposit metal on the aforementioned deposition area 14 through the released metal ions.

The parameter range of the cathode deposition is shown in Table 5 below.

TABLE 5
Parameter range of the cathode deposition (step 60)

| | Parameter range | |
|---|---|---|
| Step | Parameter of the solution | Parameter 3 |
| Cathode | Parameter 1 | Temperature: 5-95° C.; |
| deposition | Phosphoric acid and/or | Direct current: 1-70 V |
| | oxalic acid or phosphoric | Alternating current: |
| | acid and/or boric acid | 1-70 V/10 HZ-90 HZ |
| | and/or tartaric acid 1-95% | Pulse power source: |
| | plus | 1-70 V/1-254 ms |
| | Parameter 2 | Time: 1-50 minutes |
| | Sulfamate metal salt/ | |
| | Sulfuric acid metal salt/ | |
| | Nitric acid metal salt/ | |
| | Concentration: 0.1-30 g/L | |
| Water-rinsing | Temperature: 5-95° C. | 1-5 times |

Please refer to FIG. 5, which shows an enlarged cross-sectional view of the bottom of the cellular tubes 10b after metal deposition according to the instant disclosure. The instant disclosure utilizes acidic electrolyte solution with metal salt included to deposit the metal material in the deposition areas 14. The result of the cathode deposition is to form a reflective portion 16 by depositing metal in the deposition area 14 to reflect the refracted light.

Some preferred parameters for the cathode deposition of step 60 include dipping the substrate into a solution consisting essentially of sulfuric acid solution having a concentration of 20% by weight and nickel sulfamate [Ni(SO₃NH₂)₂.4H₂O] solution having a concentration of 5 g/L, where the temperature ranges from 20° C.-25° C., and a 10 volt direct current is conducted for 5 minutes. Preferably, the washing process is conducted under a temperature of approximately 25° C. for two times. The advantages of utilizing the nickel sulfamate is fast deposition rate, low internal stress of the nickel metal layer, and a strong osmosis capability of the solution. Furthermore, the nickel metal layer has fine crystalline structures with low porosity.

It is worth noting that the concentration of the solution, particularly to the concentration of the nickel sulfamate solution, and the time spent on electrical conduction can be controlled to restrain the height of the deposition of not exceeding the deposition area 14. Each deposition area 14 has a height D4 of about 0.5 nm-1 nm, and the height of the reflective portion is approximately slightly less than half of the height of the deposition area 14. If the reflective portions are too high, light interference would not likely to occur.

In order to enhance the resistance against dirt for the oxidized membrane, a sealing process of step 70 is included in the instant disclosure. The sealing process which is performed after the anodic treatment utilizes the nickel acetate type of sealing agent. The parameter range of the sealing step is shown in Table 6.

TABLE 6
Parameter range of the sealing process (step 70)

| | Parameter range | |
|---|---|---|
| Step | Parameter 1 | Parameter 2 |
| Sealing process | nickel acetate type of | Temperature: 5-95° C.; |
| | sealing agent: 1-15 g/L | Time: 5-90 minutes |
| Water-rinsing | Temperature: 5-95° C. | 1-5 times |

Some preferred parameters for the aforementioned sealing step include dipping the substrate into a sealing agent having a concentration of 7 g/L, where the temperature is 90±5° C., and the time spent is 30 minutes.

Last of all is the step for removal of ash such that the aluminum alloy substrate can be clean and ash-like particles attached on the surface thereof can be removed. Generally, the substrate is cleaned by acidic solution followed by water. The parameter range of the process for ash removal is shown in Table 7.

TABLE 7
Parameter range of the ash removal (step 80)

Parameter range

| Step | Parameter 1 | Parameter 2 |
|---|---|---|
| Ash removing | Acid: 1-500 g/L | Temperature: 5-95° C. |
| Water-rinsing | Temperature: 5-95° C. | 1-5 times |

The instant disclosure is applicable to housings of electronic products. Preferably, a nitric acid having a concentration of 20 ml/L and under a temperature of approximately 25° C. is required in the process of ash removal. Followed on, at least two times of washing using water is suggested, where the temperature of the water is approximately 25° C.

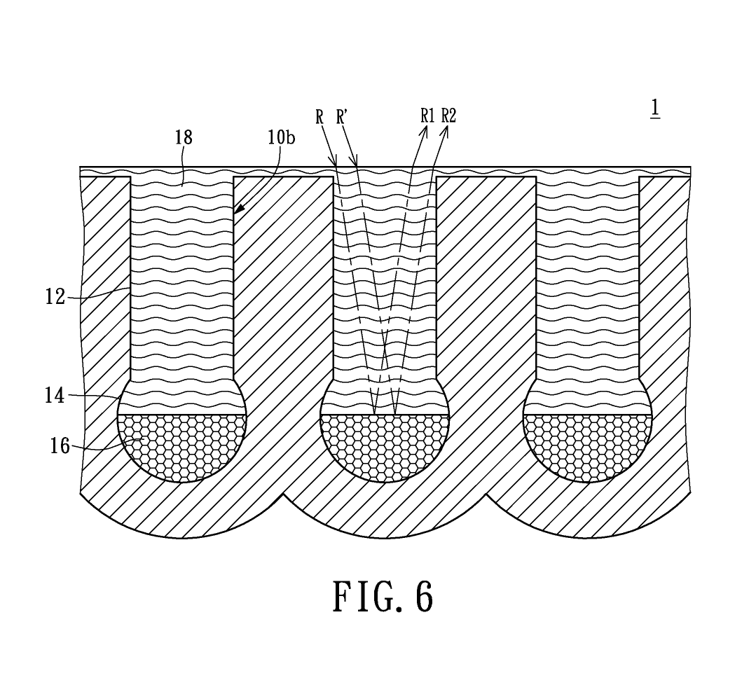

Please refer to FIG. 6, based on the method of forming an interference film on the aluminum alloy surface, an interference film structure 1 is provided on the surface of the aluminum alloy. The interference film structure 1 is provided on an oxidized membrane of an aluminum alloy substrate, where the oxidized membrane includes a plurality of expanded cellular tubes 10a. The interference film structure 1 further includes deposition areas 14 formed on the bottom of the cellular tubes 10a. The diameter of the deposition areas 14 is greater than that of the cellular tubes 10a. Reflective portions 16 are formed by metallic ions deposited in the deposition areas 14. A sealing layer 18 covers the oxidized membrane.

Based on the above, the characteristics of the interference film structure on the aluminum alloy surface of the instant disclosure are described in the following. When light R is impinged into the holes of the aluminum alloy, the light R is reflected by the reflective portions 16, where the reflected light is denoted as R1. Meanwhile, another beam of light R′ is impinged into the aluminum alloy hole to form a light R2. As the wave length of the light R1 and R2 is different, therefore light interference will occur. In other words, different colors will appear on the aluminum alloy surface when observing from different angles. Thus, enhancing the aluminum alloy surface aesthetically.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A method of forming an interference film on an aluminum alloy surface, comprising the steps of:
providing an aluminum alloy substrate;
cleaning the surface of the aluminum alloy substrate through a pre-treatment process;
anodizing the aluminum alloy substrate for a predetermined amount of time until an oxidized film having a plurality of cellular tubes is formed on the surface of the aluminum alloy substrate;
expanding the diameter of the cellular tubes of the oxidized membrane of the aluminum alloy substrate by an acidic solution;
enlarging the bottom portions of the cellular tubes to form a plurality of deposition areas through an electrical enlarging process;
depositing a metal material in the deposition areas of the cellular tubes to form an interference structure;
sealing the cellular tubes with a sealing agent; and
removing dirt from the aluminum substrate.

2. The method of forming an interference film on an aluminum alloy surface according to claim 1, wherein the pre-treatment process includes degreasing, alkaline etching, first pickling, chemical polishing, and second pickling.

3. The method of forming an interference film on an aluminum alloy surface according to claim 1, wherein the anodic treatment includes dipping the substrate into a sulfuric acid solution having a concentration of 20%-25% by weight with a temperature ranging from 15° C.-25° C., while the current density is 1.4 A/dm², and the anodizing time is at least 30 minutes.

4. The method of forming an interference film on an aluminum alloy surface according to claim 1, wherein the step of using the acidic solution for hole expansion of the oxidized membrane includes dipping the substrate into a phosphoric acid solution having a concentration of 85% by weight, with the temperature of the acidic solution ranges from 20° C.-25° C., and the dipping time is 7 minutes.

5. The method of forming an interference film on an aluminum alloy surface according to claim 4, wherein the electrical enlarging process includes connecting the aluminum alloy substrate to the anode and dipping the substrate into a phosphoric acid solution having a concentration of 150 g/L, while the temperature of the phosphoric acid solution ranges from 20° C.-25° C., and a 10 volt direct current is conducted for 5 minutes.

6. The method of forming an interference film on an aluminum alloy surface according to claim 1, wherein the process of depositing the metal material includes connecting the aluminum alloy substrate to the cathode and dipping the substrate into a sulfuric acid solution having a concentration of 20% by weight and an nickel sulfamate solution having a concentration of 5 g/L at a temperature ranging from 20° C.-25° C., and a 10 volt direct current is conducted for 5 minutes.

7. The method of forming an interference film on an aluminum alloy surface according to claim 1, wherein the sealing process includes dipping the substrate into a sealing agent having a concentration of 7 g/L, while the temperature of the sealing agent is 90±5° C., and the time spent is 30 minutes.

8. The method of forming an interference film on an aluminum alloy surface according to claim 1, wherein the process of ash removal includes the utilization of a nitric acid having a concentration of 20 ml/L.

9. An interference film structure on an oxidized membrane of an aluminum alloy surface, wherein the oxidized membrane includes a plurality of cellular tubes, comprising:
a plurality of deposition areas formed on the bottom of the cellular tubes, wherein the diameter of the deposition areas is greater than that of the cellular tubes;
a plurality of reflective portions formed by metallic ions and partially deposited on the deposition areas;
a sealing layer covered on the oxidized membrane.

10. The interference film structure on the aluminum alloy surface according to claim 9, wherein the reflective portions are made of nickel.

11. The interference film structure on the aluminum alloy surface according to claim 9, wherein the height of each deposition area ranges from 0.5 nm to 1 nm, and the height of each reflective portion is lower than that of the deposition area.
